(19) United States
(12) Patent Application Publication
(10) Pub. No.: US 2017/0163169 A1
(43) Pub. Date: Jun. 8, 2017

(54) RECTIFYING CIRCUIT FOR HIGH-FREQUENCY POWER SUPPLY

(71) Applicant: Mitsubishi Electric Engineering Company, Limited, Chiyoda-ku, Tokyo (JP)

(72) Inventors: Yoshiyuki AKUZAWA, Chiyoda-ku (JP); Kiyohide SAKAI, Chiyoda-ku (JP); Toshihiro EZOE, Chiyoda-ku (JP); Yuki ITO, Chiyoda-ku (JP)

(73) Assignee: Mitsubishi Electric Engineering Company, Limited, Chiyoda-ku, Tokyo (JP)

(21) Appl. No.: 15/039,145

(22) PCT Filed: Dec. 26, 2013
(86) PCT No.: PCT/JP2013/084825

§ 371 Date: May 25, 2016

(51) Int. Cl. H02M 7/04; H02M 1/14

(52) U.S. Cl. CPC H02M 7/04; H02M 1/14

(57) ABSTRACT

Disclosed is a rectifying circuit for high-frequency power supply that rectifies an alternating voltage at a high frequency equal to or higher than 2 MHz, the rectifying circuit for high-frequency power supply including half-wave rectifier circuit that rectifies the alternating voltage inputted from a reception antenna for power transmission 10, a partial resonance circuit that causes the half-wave rectifier circuit to perform partial resonance switching in a switching operation at the time of rectification, a matching functional circuit that has a function of matching a resonance condition to that of the reception antenna for power transmission 10, and a function of matching the resonance condition to that of the partial resonance circuit, and a smoothing functional circuit that smooths the voltage rectified by the half-wave rectifier circuit into a direct voltage.

### FIELD OF THE INVENTION

The present invention relates to a rectifying circuit for high-frequency power supply that rectifies an alternating current power supply at a high frequency.

### BACKGROUND OF THE INVENTION

A half-wave rectifier circuit according to a conventional technology is shown in FIG. 10. In the half-wave rectifier circuit, an inputted alternating voltage Vin having a frequency of around 100 kHz rectified by a synchronous rectification method based on a Field Effect Transistor (FET), and the resultant is converted into a direct voltage, and the direct voltage is outputted (for example, refer to patent reference 1).

### RELATED ART DOCUMENT

### Patent Reference

Patent reference 1: Japanese Unexamined Patent Application Publication No. 2001-309580

### SUMMARY OF THE INVENTION

### Problems to be Solved by the Invention

However, in the conventional configuration, because the technique is premised on a frequency band of around 100 kHz using the synchronous rectification method based on the FET, a problem is that when the technique is applied to the rectification at a high frequency equal to or higher than a MHz band, the power conversion efficiency is poor. Particularly, in a case where a circuit, such as a resonant type reception antenna, which has high frequency characteristics in its output impedance is connected to an input side of the half-wave rectifier circuit, an influence is exerted upon the operation of the half-wave rectifier circuit itself, and an efficient power conversion operation which is an essential object cannot be maintained.

Then, the power loss in the circuit which occurs at the time of the rectifying operation results in thermal energy and hence raises a temperature of the circuit board. This results in an increase in the operating environment temperature of the circuit board and a reduction in the life of the used parts. Therefore, a measure, such as a measure of providing an exhaust heat device, is needed, and the conventional configuration also causes an increase in cost, upsizing, and an increase in mass.

The present invention is made in order to solve the above-mentioned problems, and it is therefore an object of the present invention to provide a rectifying circuit for high-frequency power supply that can provide a high power conversion efficiency characteristic in rectification of an alternating voltage at a high frequency equal to or higher than MHz.

### Means for Solving the Problem

According to the present invention, there is provided a rectifying circuit for high-frequency power supply that rectifies an alternating voltage at a high frequency equal to or higher than 2 MHz, the rectifying circuit for high-frequency power supply including a half-wave rectifier circuit that rectifies the alternating voltage inputted from a reception antenna for power transmission, a partial resonance circuit that causes the half-wave rectifier circuit to perform partial resonance switching in a switching operation at the time of rectification, a matching functional circuit that has a function of matching a resonance condition to that of the reception antenna for power transmission, and a function o matching the resonance condition to that of the partial resonance circuit, and a smoothing functional circuit that smooths the voltage rectified by the half-wave rectifier circuit into a direct voltage.

### Advantages of the Invention

Because the rectifying circuit for high-frequency power supply according to the present invention is configured as above, a high power conversion efficiency characteristic can be provided in the rectification of the alternating voltage at a high frequency equal to or higher than 2 MHz.

### BRIEF DESCRIPTION OF THE FIGURES

FIG. 1 is a diagram showing the configuration of a rectifying circuit for high-frequency power supply according to Embodiment 1 of the present invention;

FIG. 2 is a diagram showing another example of the configuration of the rectifying circuit for high-frequency power supply according to Embodiment 1 of the present invention;

FIG. 3 is a diagram showing another example of the configuration of the rectifying circuit for high-frequency power supply according to Embodiment 1 of the present invention;

FIG. 4 is a diagram showing another example of the configuration of the rectifying circuit for high-frequency power supply according to Embodiment 1 of the present invention:

FIG. 5 is a diagram showing another example of the configuration of the rectifying circuit for high-frequency power supply according to Embodiment 1 of the present invention;

FIG. 6 is a diagram showing another example of the configuration of the rectifying circuit for high-frequency power supply according to Embodiment 1 of the present invention;

FIG. 7 is a diagram showing another example of the configuration of the rectifying circuit for high-frequency power supply according to Embodiment 1 of the present invention (in a case in which a variable resonance condition LC circuit is disposed);

FIG. 8 is a diagram showing another example of the configuration of a rectifying circuit for high-frequency power supply according to Embodiment 2 of the present invention (in a case in which an FET is used instead of a diode);

FIG. 9 is a diagram showing another example of the configuration of the rectifying circuit for high-frequency power supply according to Embodiment 2 of the present invention (in a case in which a diode and an FET are used); and

FIG. 10 is a diagram showing the configuration of a conventional rectifying circuit for high-frequency power supply.

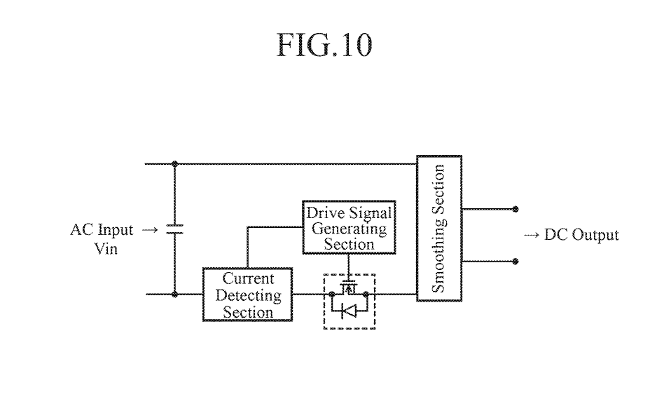

### EMBODIMENTS OF THE INVENTION

Hereafter, the preferred embodiments of the present invention will be explained in detail with reference to the drawings.

### Embodiment 1

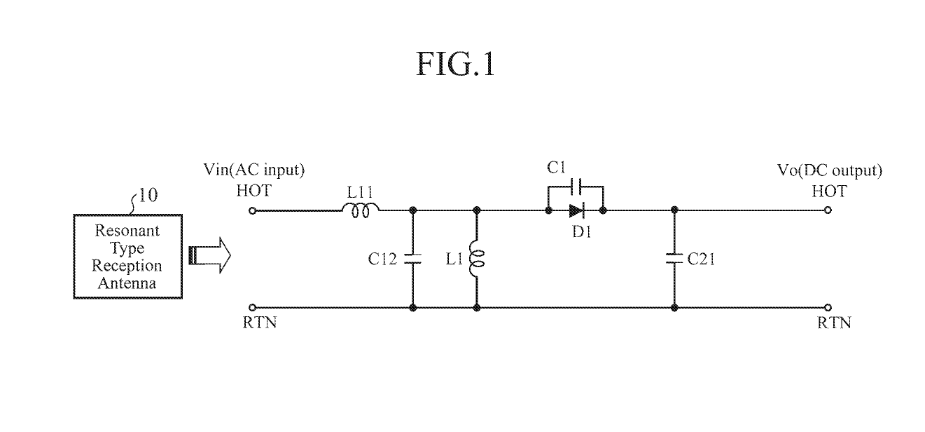

FIG. 1 is a diagram showing the configuration of a rectifying circuit for high-frequency power supply according to Embodiment 1 of the present invention.

The rectifying circuit for high-frequency power supply rectifies an alternating voltage Vin at a high frequency equal to or higher than 2 MHz. This rectifying circuit for high-frequency power supply is configured with a diode D1 capacitors C1 and C12, an inductor L1, a capacitor C21 and an inductor L11, as shown in

A resonant type reception antenna (a reception antenna for power transmission) 10 is a resonant type antenna for power transmission having LC resonance characteristics (which is not limited only to a noncontact type one). This resonant type reception antenna 10 can be of any of magnetic-field resonance type, electric-field resonance type, and electromagnetic induction type.

The diode D1 is a rectifying element that constructs a half-wave rectifier circuit for converting the alternating voltage Vin at a high frequency equal to or higher than 2 MHz, which is inputted from the resonant type reception antenna 10, into a direct voltage. As the diode D1, not only a diode for high frequency (RF; Radio Frequency) but also an element, such as a diode of, for example, a Si type, SiC type or GaN type, or Schottky barrier diode, can be used.

The capacitors C1, C12 and the inductor L1 construct a partial resonance circuit for a rectifying operation in the diode D1 by using a compound function. This partial resonance circuit causes the diode D1 perform partial resonance switching in a switching operation at the time of rectification. The capacitor C1 is a constant that consists of either the parasitic capacitance of the diode D1 or combined capacitance of the parasitic capacitance and the capacitance of a discrete element. Further, as the capacitor C12, a ceramic capacitor, a film capacitor or the like can be used. Further, as the inductor L1, an air-core coil, a magnetic material coil or the like can be used.

The capacitor C21 is an element that constructs a smoothing functional circuit for smoothing a ripple voltage after being rectified by the diode D1 into a direct voltage. As the capacitor C21, an element, such as a ceramic capacitor, a tantalum capacitor or a film capacitor, can be used.

The inductor L11 and the capacitor C12 are elements which construct a matching functional circuit having a function of performing impedance matching with the resonant type reception antenna 10 on an input side (matching the resonance condition to that of the resonant type reception antenna 10), and a function of perform impedance matching with the partial resonance circuit configured with the capacitors C1 and C12 and the inductor L1 (matching the resonance condition to that of the partial resonance circuit). As the inductor L11, the air-core coil, the magnetic material coil or the like can be used. By virtue of the inductor L11 and the capacitor C12, a partial resonance switching operation can be implemented by the diode D1.

The rectifying circuit for high-frequency power supply according to the present invention is configured in this way so as to include the three functions (the matching function, the half-wave rectifying function and the smoothing function) in the single circuit configuration which is not established by using a circuit designing method of keeping those functions separated. Then, the rectifying circuit for high-frequency power supply has a function of performing matching with the output impedance of the resonant type reception antenna 10 and also performing matching with the impedance of the partial resonance circuit configured with the capacitors C1 and C12, and the inductor L1 by using a compound function according to the inductor L11 and the capacitor C12, and also has a function of causing the diode D1 to perform partial resonance switching in the switching operation at the time of rectification by using of the diode D1 is reduced.

Next, the operation of the rectifying circuit for high-frequency power supply configured as above will be explained.

First, when the alternating voltage Vin having a high frequency equal to or higher than 2 MHz is inputted from the resonant type reception antenna 10, matching with the output impedance of the resonant type reception antenna 10 and impedance matching with the partial resonance circuit configured with the capacitors C1 and C12, and the inductor L1 are achieved by the compound function according to the inductor L11 and the capacitor C12. Then, while the matching state is maintained, the inputted alternating voltage Vin is rectified into a ripple voltage having a one-sided electric potential (a positive electric potential) by the diode D1. At that time, the switching operation by the diode D1 becomes partial resonance switching operation by virtue of the compound function according to the capacitors C1, C12 and the inductor L1, and enters a ZVS (zero voltage switching) state. This state corresponds to a rectifying operation having the lowest switching loss. Then, the ripple voltage after being rectified is smoothed into a direct voltage by the capacitor C21, and the direct voltage is outputted.

Through the above-mentioned series of operations, the rectifying circuit for high-frequency power supply can rectify the inputted alternating voltage Vin having a high frequency into a direct voltage with high power conversion efficiency (equal to or greater than 90%), and output the direct voltage.

As mentioned above, because the rectifying circuit for high-frequency power supply according to this Embodiment 1 is configured in such a way as to include the function of performing impedance matching with a circuit having a high frequency characteristic in its output impedance, such as the resonant type reception antenna 10, and the function of operating as a part of the partial resonance operation of the half-wave rectifier circuit thereof, the loss at the time of the rectifying operation at a high frequency equal to or higher than a MHz band can be greatly reduced, and high power conversion efficiency (efficiency of 90% or more) can be achieved.

Further, because the power loss in the circuit which occurs at the time of the rectifying operation is small, and hence the heat energy generated is also small and the temperature rise of the circuit board is suppressed to a low value, the influence of the operating environment temperature on the life of the used parts can be reduced. Therefore, a measure, such as a measure of providing a conventional exhaust heat device, is not needed, and a cost reduction, downsizing, a weight reduction and low power consumption can be achieved.

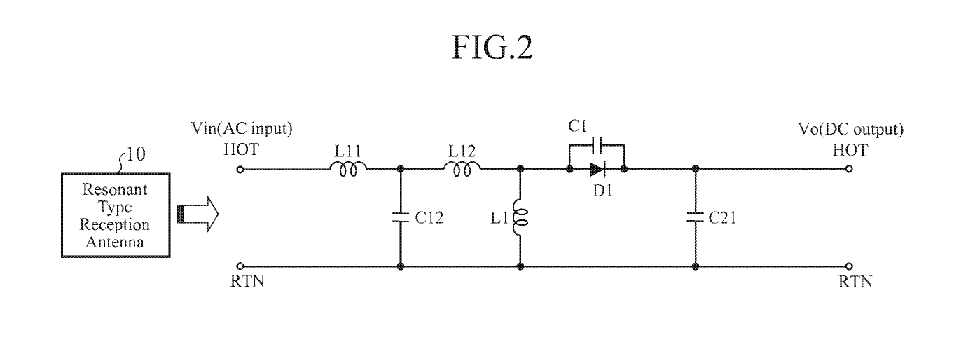

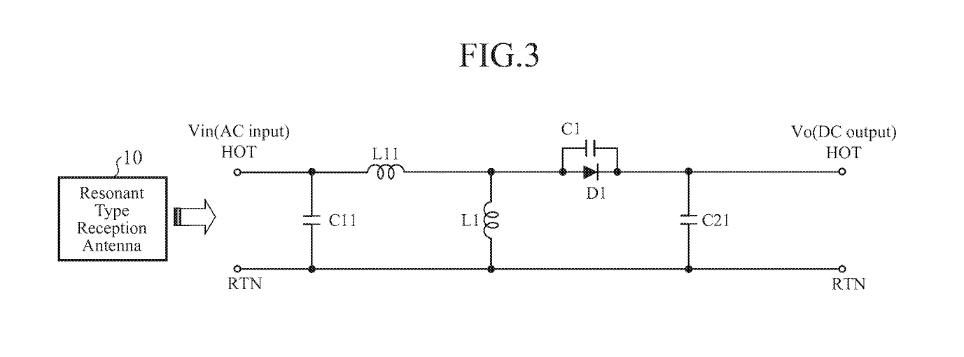

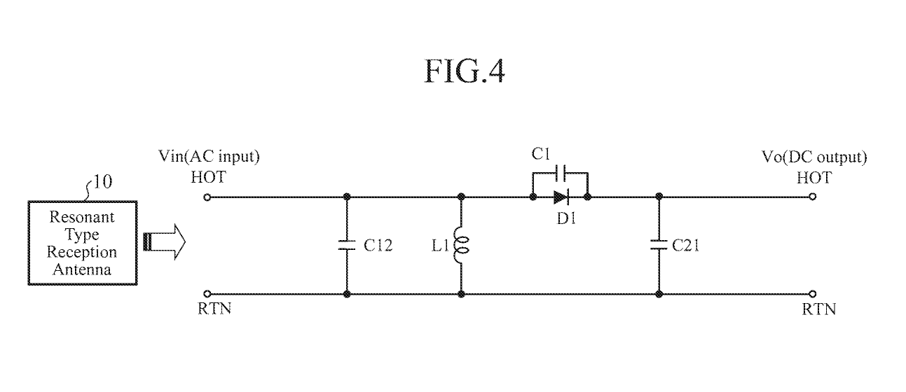

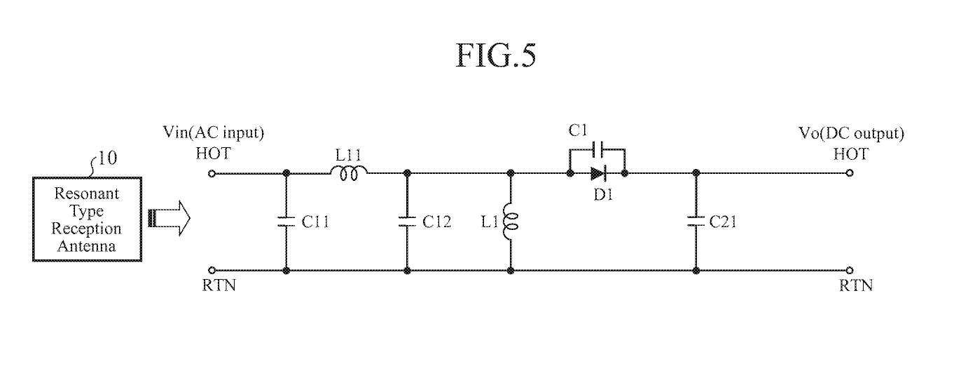

Incidentally, the case in which the rectifying circuit for high-frequency power supply is configured using the diode D1, the capacitors C1 and C12, the inductor L1, the capacitor C21, and the inductor L11 is shown in FIG. 1. However, this embodiment is not limited to this example. For example, the rectifying circuit for high-frequency power supply can have a configuration as shown in any one of FIGS. 2 to 6. In this case, the rectifying circuit for high-frequency power supply can have a configuration which is an optimal one selected from among the configurations shown in FIGS. 1 to 6 according to both the configuration (the output impedance) of the resonant type reception antenna 10, and the input impedance of a device which is connected to the output (DC output) of the rectifying circuit for high-frequency power supply.

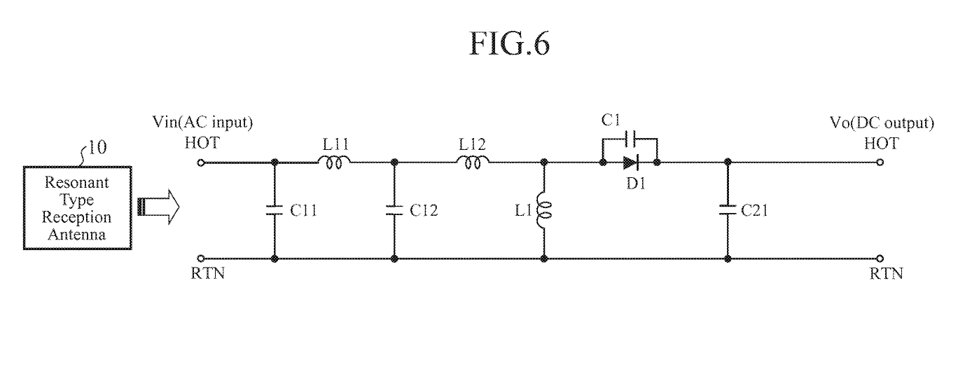

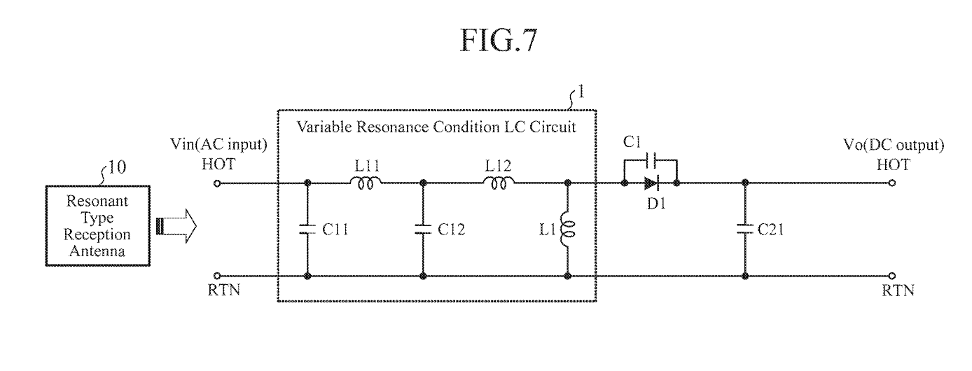

Further, although the explanation is made as to the example shown in FIG. 1 by assuming that the constants of the inductor L11 and the capacitor C12 which construct the matching functional circuit are fixed and the resonance condition is fixed, this embodiment is not limited to this example. A variable resonance condition LC circuit 1 that causes the resonance condition to be variable can be used, as shown in, for example, FIG. 7. FIG. 7 shows an example in which the variable resonance condition LC circuit 1 is applied to the configuration shown in FIG. 6 and having the largest parts count among the configurations shown in FIGS. 1 to 6, and the variable range of the resonance condition is the widest. In the example of FIG. 7, the variable resonance condition LC circuit 1 causes the constants of the inductors L1, L11 and L12 and the capacitors C11 and C12 to be variable.

The variable resonance condition LC circuit 1 can be applied similarly to the examples shown in FIGS. 1 to 5

### Embodiment 2

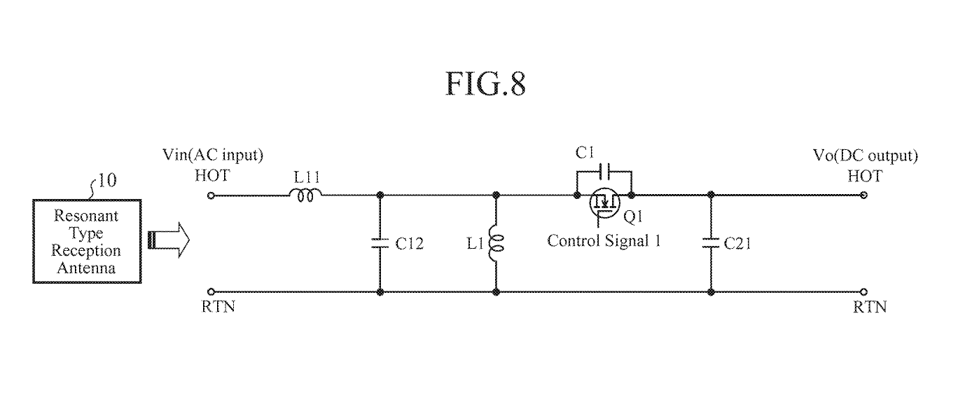

FIG. 8 is a diagram showing the configuration of a rectifying circuit for high-frequency power supply according to Embodiment 2 of the present invention. The rectifying circuit for high-frequency power supply according to Embodiment 2 shown in FIG. 8 is one in which the diode D1 of the rectifying circuit for high-frequency power supply according to Embodiment 1 shown in FIG. 1 is replaced by a power element Q1. The other components are the same as those according to Embodiment 1 and are designated by the same reference character strings, and an explanation will be made as to only a different portion.

The power element Q1 is a rectifying element that constructs a half-wave rectifier circuit for converting an alternating voltage Vin at a high frequency equal to or higher than 2 MHz, which is inputted from a resonant type reception antenna 10, into a direct voltage. As the power element Q1, not only a field effect transistor for RF (a FET) but also an element, such as a Si-MOSFET, SiC-MOSFET or GaN-FET, can be used. A capacitor C1 consists of either a parasitic capacitance of the power element Q1 or a combined capacitance of the parasitic capacitance and the capacitance of a discrete element.

Even in the case in which the rectifying circuit for high-frequency power supply is configured using the power element Q1 in this way, instead of using the diode D1, the same advantages as those provided by Embodiment 1 can be provided.

The configuration in which the diode D1 shown in FIG. 1 is replaced by the power element Q1 is shown in FIG. 8. However, this embodiment is not limited to this example. For example, the rectifying circuit for high-frequency power supply can have a configuration in which the diode D1 shown in any one of FIGS. 2 to 6 is replaced by the power element Q1. In this case, the rectifying circuit for hi -frequency power supply can have a configuration which is an optimal one selected from among configurations in which the diode D1 shown in FIGS. 1 to 6 is replaced by the power elements Q1, according to both the configuration (the output impedance) of the resonant type reception antenna 10, and the input impedance of a device which is connected to the output (DC output) of the rectifying circuit for high-frequency power supply.

Further, although the explanation is made as to the example shown in FIG. 8 by assuming that the constants of the inductor L11 and the capacitor C2 which construct the matching functional circuit are fixed and the resonance condition is fixed, this embodiment is not limited to this example. A variable resonance condition LC circuit 1 that causes the resonance condition to be variable can be used. Further, also in the configuration in which the diode D1 shown in any one of FIGS. 2 to 6 is replaced by the power element Q1, a variable resonance condition LC circuit 1 can be similarly applied.

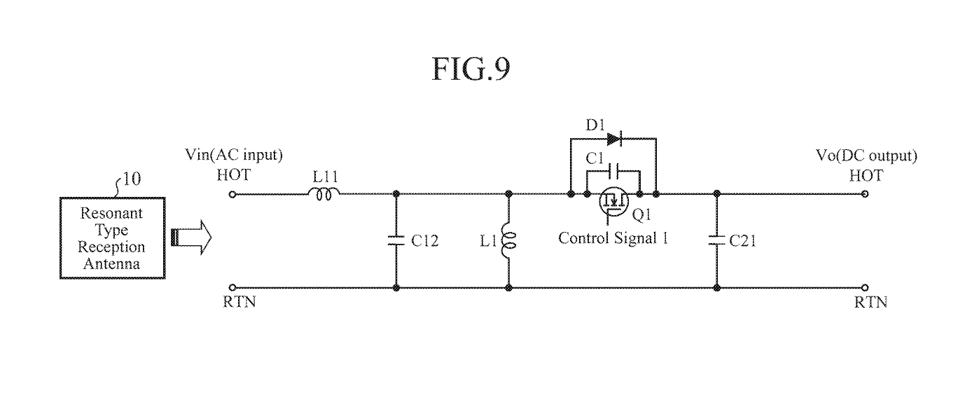

Further, the case in which the diode D1 is used as the rectifying element is shown in Embodiment 1 while the case in which the power element Q1 is used as the rectifying element is shown in Embodiment 2. In contrast with this, both the diode D1 and the power element Q1 can be used as the rectifying element, as shown in FIG. 9. Although FIG. 9 shows the case in which the rectifying element shown in FIG. 1 is replaced by the rectifying element in which the diode D1 and the power element Q1 are used, this embodiment is not limited to this example. For example, the rectifying element shown in any one of FIGS. 2 to 6 can be replaced by the rectifying element in which the diode D1 and the power element Q1 are used. In addition, the variable resonance condition LC circuit 1 can be applied to any one of these configurations.

In addition, while the invention has been described in its referred embodiments, it to be understood that an arbitrary combination of two or more of the embodiments can be made, various changes can be made in an arbitrary component according to any one of the embodiments, and an arbitrary component according to any one of the embodiments can be omitted within the scope of he invention.

### INDUSTRIAL APPLICABILITY

The rectifying circuit for high-frequency power supply according to the present invention provide a high power conversion efficiency characteristic in the rectification of an alternating voltage at a high frequency equal to or higher than 2 MHz, and is suitable for use as a rectifying circuit for high-frequency power supply or the like that rectifies an alternating current power supply at a high frequency.

### EXPLANATIONS OF REFERENCE NUMERALS

1 variable resonance condition LC circuit, and 10 resonant type reception antenna (reception antenna for power transmission).

1. A rectifying circuit for high-frequency power supply that rectifies an alternating voltage at a high frequency equal to or higher than 2 MHz, said rectifying circuit for high-frequency power supply comprising:
a half-wave rectifier circuit that rectifies said alternating voltage inputted from a reception antenna for power transmission;
a partial resonance circuit that causes said half-wave rectifier circuit to perform partial resonance switching in a switching operation at a time rectification;
a matching functional circuit that has a function of matching a resonance condition to that of said reception antenna for power transmission, and a function of matching the resonance condition to that of said partial resonance circuit; and
a smoothing functional circuit that smooths the voltage rectified by said half-wave rectifier circuit into a direct voltage.

2. The rectifying circuit for high-frequency power supply according to claim 1, wherein said half-wave rectifier circuit is configured using a diode.

3. The rectifying circuit for high-frequency power supply according to claim 2, wherein said diode is one other than a diode for high frequency.

4. The rectifying circuit for high-frequency power supply according to claim 1, wherein said half-wave rectifier circuit is configured using a field effect transistor.

5. The rectifying circuit for high-frequency power supply according to claim 1, wherein said half-wave rectifier circuit is configured using a diode and a field effect transistor.

6. The rectifying circuit for high-frequency power supply according to claim 1, wherein said matching functional circuit matches the resonance condition to that of said reception antenna for power transmission according to magnetic-field resonance.

7. The rectifying circuit for high-frequency power supply according to claim 1, wherein said matching functional circuit matches the resonance condition to that of said reception antenna for power transmission according to electric-field resonance.

8. The rectifying circuit for high-frequency power supply according to claim 1, wherein said matching functional circuit matches the resonance condition to that of said reception antenna for power transmission according to electromagnetic induction.

9. The rectifying circuit for high-frequency power supply according to claim 1, wherein said matching functional circuit causes the resonance condition to be variable.
